(19) United States
(12) Patent Application Publication
(10) Pub. No.: US 2021/0167668 A1
(43) Pub. Date: Jun. 3, 2021

(54) THERMALLY-CONDUCTIVE SLOT DIVIDER

(71) Applicant: BorgWarner, Inc., Auburn Hills, MI (US)

(72) Inventor: Jeffrey Carter, Mirfield (GB)

(21) Appl. No.: 17/108,570

(22) Filed: Dec. 1, 2020

Related U.S. Application Data
(60) Provisional application No. 62/942,865, filed on Dec. 3, 2019.

(51) Int. Cl. H02K 9/22; H02K 1/14; H02K 3/32

(52) U.S. Cl. CPC H02K 9/223; H02K 3/325; H02K 1/146

(57) ABSTRACT

A stator assembly used in an electrical machine that includes a stator core having an axial length and a plurality of stator slots that each are configured to receive electrical windings; a slot liner, received by each stator slot, that includes an aperture exposing a portion of the stator core; and a slot divider, positioned adjacent to each slot liner and partitioning each stator slot, comprising an electrically-non-conductive and thermally-conductive material, wherein the slot divider extends through the aperture in the slot liner to abut the stator core thereby communicating thermal energy from the electrical windings to the stator core.

### TECHNICAL FIELD

The present application relates to electrical machines and, more particularly, to stators used with electrical machines.

### BACKGROUND

Electrical machines use a rotor coupled with a shaft and a stator that concentrically receives the rotor. The stator includes electrical windings that receive electrical current from an electrical source. The electrical current flowing through the windings induces rotational movement of the rotor through electromagnetic induction. The flow of electrical current through the windings produces heat as a byproduct. It is helpful to remove at least some of the heat generated by the windings from electrical machines.

### SUMMARY

In one implementation, a stator assembly used in an electrical machine includes a stator core having an axial length and a plurality of stator slots that each are configured to receive electrical windings; a slot liner, received by each stator slot, that includes an aperture exposing a portion of the stator core; and a slot divider, positioned adjacent to each slot liner and partitioning each stator slot, comprising an electrically-non-conductive and thermally-conductive material, wherein the slot divider extends through the aperture in the slot liner to abut the stator core thereby communicating thermal energy from the electrical windings to the stator core.

In another implementation, a stator assembly used in an electrical machine includes a stator core having an axial length and a plurality of stator slots that each are configured to receive electrical windings; a rotor coupled with an output shaft; a slot liner, received by each stator slot, that includes an aperture exposing a portion of the stator core and extends axially along an axis of shaft rotation beyond the stator core; and a slot divider, positioned adjacent to each slot liner and partitioning each stator slot, comprising an electrically-non-conductive and thermally-conductive material, wherein the slot divider extends through the aperture in the slot liner to abut the stator core thereby communicating thermal energy from the electrical windings to the stator core and a portion of the slot divider receives fluid from the output shaft.

### BRIEF DESCRIPTION OF THE DRAWINGS

FIG. 1 is a perspective view depicting an implementation of an electrical machine with a stator assembly;

FIG. 2 is a cross-sectional view depicting an implementation of an electrical machine with a stator assembly;

FIG. 3 is another cross-sectional view depicting an implementation of an electrical machine with a stator assembly;

FIG. 4 is another cross-sectional view depicting an implementation of an electrical machine with a stator assembly; and

FIG. 5 is another cross-sectional view depicting an implementation of an electrical machine with a stator assembly.

### DETAILED DESCRIPTION

A stator assembly used in an electrical machine, such as an electrical motor, includes a stator core having a plurality of stator slots that receive electrical windings, a slot liner positioned in each stator slot, that includes an aperture exposing a portion of the stator core, and a slot divider, received by each slot liner. The slot liners may be made of electrically insulating material whereas the slot dividers can be made from a thermally-conductive material yet electrically isolating and partition each stator slot into separate sections. The slot dividers extend through the apertures in the slot liners to abut the stator core and communicate thermal energy from the electrical windings to the stator core. The stator assembly can be used with electrical machines having a stator with concentrated windings and, optionally, electrical machines that are cooled with fluid, such as oil. Electrical machines can be implemented using any one of a number of different designs. Some electrical machine designs use stators having concentrated windings. The slot dividers can separate concentrated windings. In some implementations, oil emitted from a shaft bearing of a rotor or a shaft coupled to the rotor can be directed so that the oil flows across an outer surface of the slot divider and conduct heat away from the electrical windings.

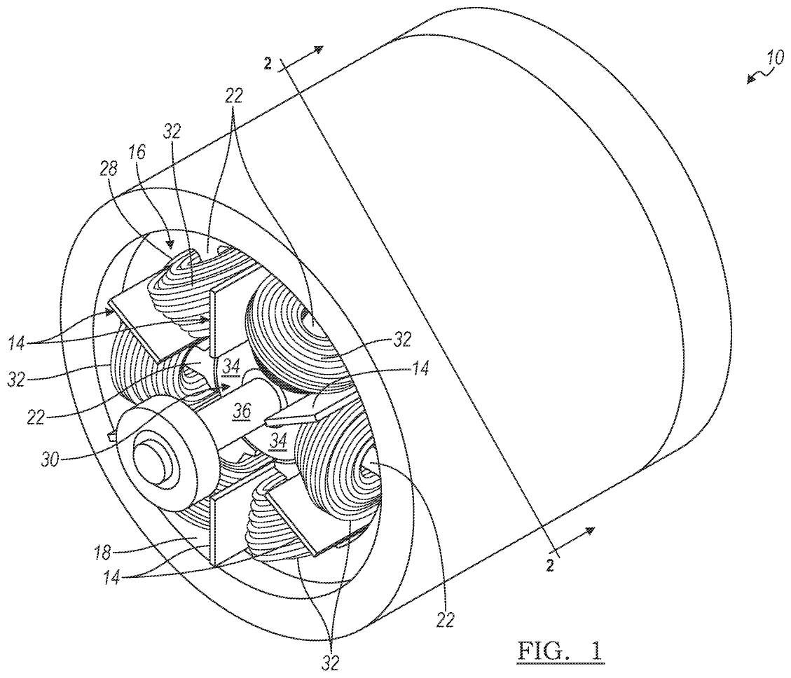

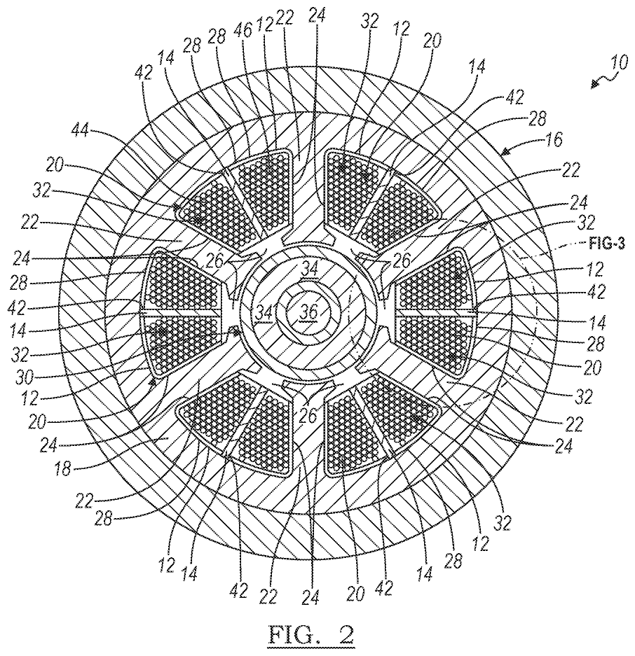

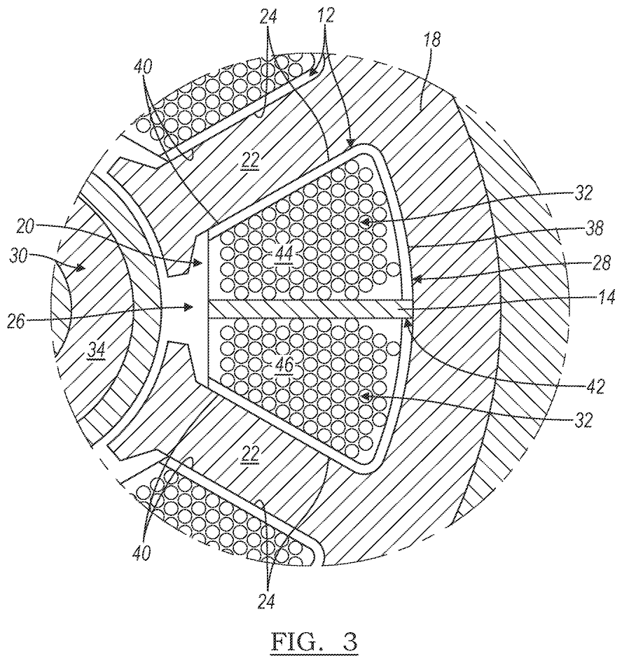

Turning to FIGS. 1-3, an electrical machine 10 having slot liners 12 and slot dividers 14 is shown. The electrical machine 10 is an electrical motor. But the concepts described herein can also be applied to other electrical machines, such as alternators and generators. The electrical machine 10 includes a stator assembly 16. The stator assembly 16 comprises a stator core 18 having a plurality of slots 20 that are circumferentially arranged around the stator core 18. The stator core 18 can be made in a variety of different ways. For example, the stator core 18 can be assembled from laminated layers of a ferric material that may be referred to as lamination steel or electrical steel. The layers can be stacked together and then welded or otherwise bonded together to form a unitary item. The slots 20 can be formed in the stator core 18 between radially-inwardly-facing arms 22. Surfaces 24 of the radially-inwardly-facing arms 22 can at least partially define a slot 20; the slot 20 can have an open end 26 proximate an axis (x) of rotor rotation and a closed end 28 distal to the axis (x). The number of radially-inwardly-facing arms 22, as well as the number of slots 20, can be selected based on the number of poles of the electrical machine 10. The stator core 18 and the slots can have a defined axial length measured parallel to the axis (x). A rotor assembly 30 can be positioned radially-inwardly from the slots 20 and concentric with the electrical windings 32 held by the slots 20. The rotor assembly 30 can include a plurality of permanent magnets 34 and couple with a motor shaft 36. As alternating current (AC) electrical current flows through the electrical windings 32 included with the stator assembly 16, a rotating magnetic field is induced in the electrical windings 32 thereby forcing angular movement in the rotor assembly 30. The AC current can be received directly from an AC electrical power source (not shown), or supplied by converting direct current (DC) supplied by a DC electrical power source (not shown) to AC electrical current. In this implementation, the electrical machine 10 includes six slots 20 formed by six radially-inwardly-facing arms 22. The six slots accommodate electrical windings 32 for a six-pole electric motor. However, other implementations of electrical machines are possible using a different quantity of slots and poles. The electrical windings 32 will be discussed in more detail below.

The slots 20 receive slot liners 12 that can insulate electrical windings 32 from the stator core 18, including the radially-inwardly-facing arms 22 and closed end 28. The slot liners 12 can be substantially U-shaped in a way that closely conforms with and abuts a slot surface 38. That is, the shape of the slot liner 12 can mimic the shape of the surfaces of the radially-inwardly-facing arms and the closed end 28 of the slot 20. After insertion into the slot 20, an outer surface 40 of the slot liner 12 presses against the slot surface 38 and the closed end 28 thereby providing a material having a thickness that electrically insulates at least a portion of the stator core 18 from the electrical windings 32.

The slot liners 12 include an aperture 42 that exposes a portion of the closed end 28 so that a slot divider 14 can be positioned in the slot 20 so that the slot divider 14 extends through the aperture 42 to abut and contact the closed end 28 thereby touching the material of the stator core 18. The aperture 42 in the slot liner 12 can be sized and shaped to closely conform to the length and width of the slot divider 14 such that the aperture 42 encircles an outer surface of the slot divider 14. After insertion into the slot 20, the slot divider 14 can extend from the closed end 28 of the stator core 18 toward the axis of rotor rotation (x) bifurcating the slot 20 into a first section 44 and a second section 40. In addition, the slot divider 14 can extend beyond the slot 20 along the axis of rotor rotation (x) so that at least a portion of the slot divider 14 extends outside of the slot 20. The slot divider 14 can be longer than the stator assembly 16 measured along the axis of rotor rotation (x). The slot divider 14 can be constructed from an electrically non-conductive material that is also thermally conductive. That is, the slot divider 14 electrically isolates adjacent concentrated windings yet readily communicates heat away from the electrical windings. For example, the slot divider 14 can be formed from sintered metal with electrically isolated metal grains in a particular shape and cross-section. It is possible to retain the slot divider 14 in the aperture 42 using an adhesive, such as potting compound or other similar material. The slot divider 14 can conduct heat away from the electrical windings 32 and into the stator assembly 16.

The slots 20 can receive the electrical windings 32 used by the stator assembly 16. Each radially-inwardly-facing arm 22 can include an electrical winding 32 (or pole of the winding) of metal wire that encircles or is wrapped around the arm 22 and have a portion of the electrical winding 32 in the first section 44 of the slot 20 and another portion of the electrical winding 32 in the second section 44 of the slot 20. The electrical windings 32 of the electrical machine 10 can be arranged in a concentrated winding pattern with concentrated electrical windings 32 at each radially-inwardly-facing arm 22. The slot dividers 14 can physically isolate an electrical winding 32 wrapped around one radially-inwardly-facing arm 22 from the electrical winding 32 wrapped around another adjacent radially-inwardly-facing arm 22. As AC electrical current is supplied to the electrical windings 32, the rotor assembly 30 is angularly displaced relative to the stator assembly 16. Heat is generated by the electrical winding 32 as a byproduct of AC electrical current flow. The heat can be absorbed by the slot divider(s) 14 and communicated from the electrical windings 32 to the stator assembly 16 through the aperture 42 in the slot liner 12. It is also possible for the portion of the slot divider(s) 14 extending outside of the slots 20 of the stator assembly 16 to receive a flow of fluid that removes heat from the slot divider 14 and thereby reduces the temperature of the electrical windings 32. For example, the motor shaft 36 of the electrical machine 10 can produce a flow of oil or other lubricant. As the motor shaft 36 rotates, the oil can move radially-outward relative to the motor shaft 36 and flow across an outer surface of the slot divider(s) 14. The flow of oil over the outer surface can carry out a cooling effect and reduce the temperature of the electrical windings 32.

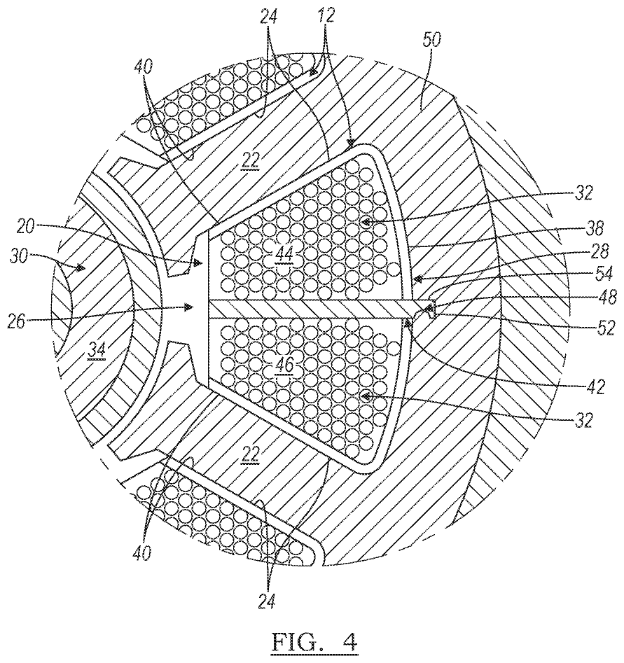

Another embodiment of a slot divider 48 and a stator core 50 used with the electrical machine 10 is shown in FIG. 4. The slot divider 48 can include a keyed end 52 that may help couple the slot divider 48 to the stator core 50. The slot surface 38 can include a socket 54 having a shape that closely conforms to the keyed end 52. The slot liner 12 includes the aperture 42 that exposes the socket 54 so that the slot divider 48 can be positioned in the slot 20 so that the slot divider 48 extends through the aperture 42 and the keyed end 52 is received by the socket 54. The depth of the socket 54 can be selected based on the magnetic flux flowing around the stator core 50 so that the presence of the slot divider 48 in the stator core minimizes interruption of the flux. In this implementation, the keyed end 52 includes a semi-circular keyway that corresponds to a semi-circular key way included in the socket 54. The engagement of these semi-circular keyways can prevent radially-inward movement of the slot divider 48 toward the rotor assembly 30.

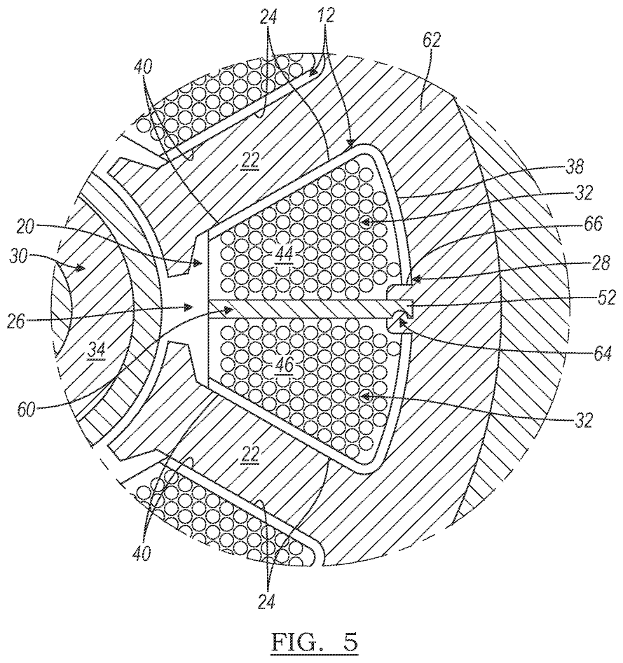

Turning to FIG. 5, another implementation of a slot divider 60 and a stator core 62 used with the electrical machine 10 is shown. The slot divider 60 can include the keyed end 52 discussed above with respect to FIG. 4. The stator core 62 can include a raised socket 64 that extends radially-inwardly toward the rotor assembly 30 through an aperture 66. In some implementations, the raised socket 64 can extend into the slot 20. In this implementation, the keyed end 52 includes a semi-circular keyway that corresponds to a semi-circular key way included in the raised socket 64. The engagement of these semi-circular keyways can prevent radially-inward movement of the slot divider 60 toward the rotor assembly 30.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A stator assembly used in an electrical machine, comprising:
a stator core having an axial length and a plurality of stator slots that each are configured to receive electrical windings;
a slot liner, received by each stator slot, that includes an aperture exposing a portion of the stator core; and
a slot divider, positioned adjacent to each slot liner and partitioning each stator slot, comprising an electrically-non-conductive and thermally-conductive material, wherein the slot divider extends through the aperture in the slot liner to abut the stator core thereby communicating thermal energy from the electrical windings to the stator core.

2. The stator assembly recited in claim 1, wherein the slot divider has an axial length that is greater than the axial length of the stator core and a portion of the slot divider extends axially beyond the stator slot.

3. The stator assembly recited in claim 2, wherein the slot divider receives fluid passing over an outer surface of the slot divider

4. The stator assembly recited in claim 1, wherein the slot divider comprises a sintered metal.

5. The stator assembly recited in claim 1, wherein the electrical windings are wound around radially-inwardly extending arms in a concentrated winding pattern.

6. The stator assembly recited in claim 1, wherein the stator core includes a socket.

7. The stator assembly recited in claim 6, wherein the slot divider includes a keyed end that is received by the socket

8. The stator assembly recited in claim 1, wherein the stator core includes a raised socket extending radially-inwardly away from a slot surface.

9. The stator assembly recited in claim 8, wherein the slot divider includes a keyed end that is received by the raised socket.

10. A stator assembly used in an electrical machine, comprising:
a stator core having an axial length and a plurality of stator slots that each are configured to receive electrical windings;
a rotor coupled with an output shaft;
a slot liner, received by each stator slot, that includes an aperture exposing a portion of the stator core and extends axially along an axis of shaft rotation beyond the stator core; and
a slot divider, positioned adjacent to each slot liner and partitioning each stator slot, comprising an electrically-non-conductive and thermally-conductive material, wherein the slot divider extends through the aperture in the slot liner to abut the stator core thereby communicating thermal energy from the electrical windings to the stator core and a portion of the slot divider receives fluid from the output shaft.

11. The stator assembly recited in claim 10, wherein the slot divider has an axial length that is greater than the axial length of the stator core.

12. The stator assembly recited in claim 10, wherein the slot divider comprises a sintered metal.

13. The stator assembly recited in claim 10, wherein the electrical windings are wound around radially-inwardly extending arms in a concentrated winding pattern.

14. The stator assembly recited in claim 10, wherein the stator core includes a socket and the slot divider includes a keyed end that is received by the socket.

15. The stator assembly recited in claim 10, wherein the stator core includes a raised socket extending radially-inwardly away from a slot surface and the slot divider includes a keyed end that is received by the raised socket.
